(19) United States
(12) Patent Application Publication
(10) Pub. No.: US 2024/0386324 A1
(43) Pub. Date: Nov. 21, 2024

(54) LEARNING MODEL GENERATOR AND LEARNING MODEL GENERATION METHOD

(71) Applicants: NEC Corporation, Tokyo (JP); NEC Platforms, Ltd., Kawasaki-shi (JP)

(72) Inventors: Shoya TOKITA, Tokyo (JP); Jun SAKAI, Tokyo (JP); Toshiki TAKEUCHI, Tokyo (JP); Ayaka HARAYAMA, Kanagawa (JP); Tsuyoshi HAMADA, Kanagawa (JP); Tomohiro SHIMODA, Kanagawa (JP)

(73) Assignees: NEC Corporation, Tokyo (JP); NEC Platforms, Ltd., Kawasaki-shi (JP)

(21) Appl. No.: 18/659,108

(22) Filed: May 9, 2024

(30) Foreign Application Priority Data
May 16, 2023 (JP) 2023-080904

(51) Int. Cl. G06N 20/00

(52) U.S. Cl. CPC G06N 20/00

(57) ABSTRACT

The learning model generator includes a data division unit which groups multiple feature data, each of which indicates a feature, and a learning model generation unit which generates a learning model using feature data belonging to a first group among multiple groups formed by the data division unit, or the feature data belonging to the first group and a part of feature data belonging to other groups, as training data.

This application is based upon and claims the benefit of priority from the prior Japanese Patent Application No. 2023-080904, filed May 16, 2023, the entire contents of which are incorporated herein by reference.

### BACKGROUND OF INVENTION

### Field of the Invention

This invention relates to a learning model generator and a learning model generation method for generating a learning model for anomaly detection.

### Description of the Related Art

Wireless communication using radio waves is used in various fields. Correspondingly, the detection of radio interference and failures in wireless communication systems, i.e., anomaly detection, is of great importance. Anomaly detection is sometimes performed using machine learning (refer to patent literatures 1 and 2, for example).
[Patent Literature 1] Japanese Patent Application Publication No. 2019-159957
[Patent Literature 2] Japanese Patent Application Publication No. 2022-182844

### SUMMARY OF INVENTION

While it is difficult to collect abnormal data for a target, normal data can be collected relatively easily. Therefore, when anomaly detection is performed using machine learning, a model (machine learning model, hereinafter referred to as a learning model) is sometimes trained by unsupervised machine learning, using normal data as the training data. Normal data is the data obtained when there is no radio interference or disturbance. Abnormal data is data obtained when there is radio interference or obstruction.

When learning is performed using only normal data, there is a possibility of false negative, in which data that should be determined as normal is determined as abnormal, when using a learned model. In addition, there is a possibility of missed detection.

A large amount of training data collected in a variety of situations are needed to reduce possibilities of false negative and missed detection. In addition, the size of the leaning model becomes large.

Since a large amount of training data is used, the size of the memory that should be prepared is large. In addition, since the size of the learning model is larger, the performance required of the computer to implement the learning model is higher. In other words, a costly computer is required.

It is an object of the present invention to provide a learning model generator and a learning model generation method that can reduce the size of a learning model and the size of a memory that should be prepared for learning.

A preferred aspect of the learning model generator includes data division means for grouping multiple feature data, each of which indicates a feature, and learning model generation means for generating a learning model using feature data belonging to a first group among multiple groups formed by the data division means, or the feature data belonging to the first group and a part of feature data belonging to other groups, as training data.

A preferred aspect of the learning model generation method includes grouping multiple feature data, each of which indicates a feature, and generating a learning model using feature data belonging to a first group among multiple groups formed, or the feature data belonging to the first group and a part of feature data belonging to other groups, as training data.

A preferred aspect of the learning model generation program causes a computer execute grouping multiple feature data, each of which indicates a feature, and generating a learning model using feature data belonging to a first group among multiple groups formed, or the feature data belonging to the first group and a part of feature data belonging to other groups, as training data.

According to the present invention, it is possible to reduce the size of a learning model and the size of a memory that should be prepared for training.

### BRIEF DESCRIPTION OF THE DRAWINGS

FIG. 1 It depicts a block diagram shows the structure of an example embodiment of the learning model generator.

FIG. 2 It depicts an explanatory diagram for explaining a process of the learning model generation unit.

FIG. 3 It depicts a flowchart shows an operation of the learning model generator.

FIG. 4 It depicts a block diagram showing an example configuration of an information processing device that can realize functions of the learning model generator.

FIG. 5 It depicts a block diagram showing the main part of the learning model generator.

### DESCRIPTION OF THE PREFERRED EMBODIMENTS

Hereinafter, an example embodiment of the present invention will be explained with reference to the drawings.

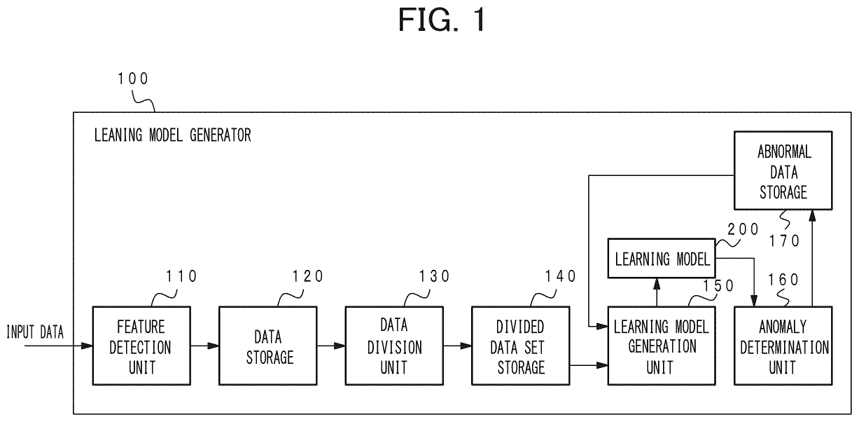

FIG. 1 is a block diagram shows the structure of an example embodiment of the learning model generator that generates a learning model for anomaly detection. The learning model generator 100 shown in FIG. 1 comprises a feature detection unit 110, a data storage (a feature storage) 120, a data division unit 130, a divided data set storage 140, a learning model generation unit 150 for generating a learning model 200, an anomaly determination unit 160, and an abnormal data storage 170. The arrows in FIG. 1 indicate the direction of signal (data) flow in a straightforward manner, but do not preclude bidirectionality. This is also true for the other block diagrams.

The learning model 200 is an estimation model that estimates whether input data is normal data or abnormal data after it has been generated, i.e., after it has been learned. Therefore, the trained learning model 200 can be used as an estimation model for anomaly detection after it has been learned.

Anomaly detection is to determine whether input data is normal or abnormal. Hereinafter, take the case, in the field of wireless communication using radio waves, of determining whether there is radio interference or radio disturbance (for example, a failure or malfunction of a system, a device, etc.) as an example. In such a case, the abnormal data is data that is acquired when there is radio interference or radio disturbance. The normal data is data acquired when there is no radio interference or radio disturbance.

During the operation of anomaly detection, i.e., during the estimation phase, the trained learning model 200 is used to output estimated data that indicates the result of estimating whether input data is normal or abnormal. Based on the estimated data, an anomaly detection process is executed. For example, the anomaly detection process is a process to detect radio interference or radio interference.

Collected data is input to the feature detection unit 110. When determining whether radio wave interference or interference is occurring, the input data is received data. Received data is, for example, data output from a receiver (not shown) that receives radio waves.

The feature detection unit 110 extracts a feature from each of the input data. In the case of determining whether or not radio interference or radio disturbance is occurring, the feature is a feature for determining whether or not radio interference is occurring, or a feature for determining whether or not radio disturbance is occurring. Specifically, a feature is, for example, a quantity indicating statistical information including information in a frequency direction and a time direction. As an example, an amplitude probability distribution (APD: Amplitude Probability Distribution), a cumulative distribution function (CDF: Cumulative Distribution Function), an amplitude histogram, and a frequency spectrum can be used as the feature.

The feature detection unit 110 stores the extracted multiple features in the data storage 120 as multiple feature data.

The data division unit 130 divides a feature data group stored in the data storage 120 into multiple groups. Hereinafter, the set of data included in the groups is referred to as a divided data set. The data division unit 130 stores the divided data sets in the divided data set storage 140.

The 200 learning model is generated by repeated machine learning using learning data (training data). Machine learning is Random Forest, Support Vector Machine, Neural Network, or Deep Neural Network. The learning model generation unit 150 generates the learning model 200 using the divided data sets stored in the divided data set storage 140 as training data. The learning model generation unit 150 may use abnormal data in addition to the divided data sets when generating the learning model 200.

Hereinafter, the abnormal data used when training the learning model 200 is referred to as “abnormal data for training” and the feature data when the estimation result by the learning model 200 is an anomaly is referred to as “determined abnormal data”.

The anomaly determination unit 160 stores the abnormal data group, which is a set of determined abnormal data, in the abnormal data storage 170. Since the learning model 200 outputs a determination result of normal/abnormal, the learning model 200 can be considered to be a part of the anomaly determination unit 160.

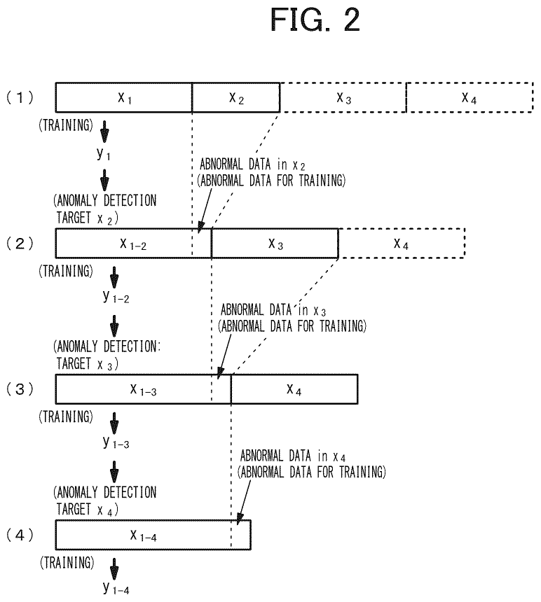

FIG. 2 is an explanatory diagram for explaining a process (training phase) of the learning model generation unit 150.

x₁ to x₄ shown in FIG. 2 indicate the divided data sets, respectively. Although the number of divided data sets, i.e., the division number of input data n (n≥2), is arbitrary, the case n=4 is illustrated in FIG. 2.

In the example shown in FIG. 2, the learning model generation unit 150 first trains a leaning model 200 using the feature data included in the divided data set x₁ as training data. The learning model 200 after training is completed is called the learning model y₁ (refer to (1) in FIG. 2). In this example embodiment, unsupervised learning is assumed as learning, but learning is not limited to unsupervised learning. In addition, as unsupervised learning, general methods such as principal component analysis, cluster analysis, self-organizing map (SOM), etc. can be used.

The anomaly determination unit 160 performs anomaly determination on the feature data included in the divided data set x₂ using the learning model y₁. The anomaly determination unit 160 stores the feature data group determined to be abnormal, i.e., the determined abnormal data group, in the abnormal data storage 170.

Next, the learning model generation unit 150 trains the learning model y₁ using the feature data included in the divided data set x₁ and the feature data included in the abnormal data group stored in the abnormal data storage 170 as training data. The learning model 200 after training is completed is the learning model y₁₋₂ (refer to (2) in FIG. 2).

The abnormal data group stored in the abnormal data storage 170 at the time of training the learning model y₁ is the feature data determined to be abnormal among the feature data included in the divided data set x₂. In FIG. 2, the set of feature data included in the divided data set x₁ and the feature data determined to be abnormal among the feature data included in the divided data set x₂ are indicated by x₁₋₂.

The anomaly determination unit 160 performs anomaly determination on the feature data included in the divided data set x₃ using the learning model y₁₋₂. The anomaly determination unit 160 stores the feature data group determined to be abnormal, i.e., the determined abnormal data group, in the abnormal data storage 170.

Next, the learning model generation unit 150 trains the learning model y₁₋₂ using the feature data included in the divided data set x₁₋₂ and the feature data included in the abnormal data group stored in the abnormal data storage 170 as training data. The learning model 200 after training is completed is the learning model y₁₋₃ (refer to (3) in FIG. 2).

The abnormal data group stored in the abnormal data storage 170 at the time of training the learning model y₁₋₂ is the feature data determined to be abnormal among the feature data included in the divided data set x₃. In FIG. 2, the set of the feature data group included in the divided data set x₁, the feature data determined to be abnormal among the feature data included in the divided data set x₂ and the feature data determined to be abnormal among the feature data included in the divided data set x₃ are indicated by x₁₋₃.

The anomaly determination unit 160 performs anomaly determination on the feature data included in the divided data set x₄ using the learning model y₁₋₃. The anomaly determination unit 160 stores the group of feature data determined to be abnormal, i.e., the determined abnormal data group, in the abnormal data storage 170.

Next, the learning model generation unit 150 trains the learning model y₁₋₃ using the feature data included in the divided data set x₁₋₃ and the feature data included in the abnormal data group stored in the abnormal data storage 170 as training data. The learning model 200 after training is completed is the learning model y₁₋₄ (refer to (4) in FIG. 2).

The abnormal data group stored in the abnormal data storage 170 at the time of training the learning model y₁₋₃ is the feature data determined to be abnormal among the feature data included in the divided data set x₄. In FIG. 2, the set of the feature data included in the divided data set x₁, the feature data determined to be abnormal among the feature data included in the divided data set x₂, the feature data determined to be abnormal among the feature data included in the divided data set x₃, and the feature data included in the divided data set x₄ is shown as x₁₋₄.

In the example shown in FIG. 2, the division number is 4. When the division number exceeds 4 (when n>4), the learning model generation unit 150 and the anomaly determination unit 160 should repeat the process of training the learning model 200 using the feature data included in the divided data set and the abnormal data obtained in the previous processes as training data, and the process of anomaly detection in the feature data included in the divided data set that has not yet been used. Finally, a learning model y₁₋ₙ is obtained.

When obtaining the learning model y₁₋ₙ, not all of the input data is used as training data during the training phase. In other words, not all of the feature data included in the n divided data sets are used as training data. In the example shown in FIG. 2, only the feature data included in the first divided data set x₁ is used as training data.

For the divided data sets x₂, x₃, and x₄ other than the divided data set x₁, only the feature data that is determined to be abnormal data is used as training data. Therefore, the number of feature data used as training data is smaller than in the case where all of a large amount of feature data is used as training data for the purpose of preventing false negative, etc. Accordingly, the size of the learning model can be reduced. In addition, the size of a memory that must be prepared during the training phase can be reduced.

The feature data in the divided data sets x₂, x₃, and x₄ that are determined to be normal data may be feature data that are similar to each other. Using a large number of similar feature data as training data does not improve the accuracy of the leaning model. In other words, when the leaning model is generated, the number of training data is reduced, but it is expected that the leaning model (trained learning model) will be as accurate as when all of the large amount of feature data is used as training data.

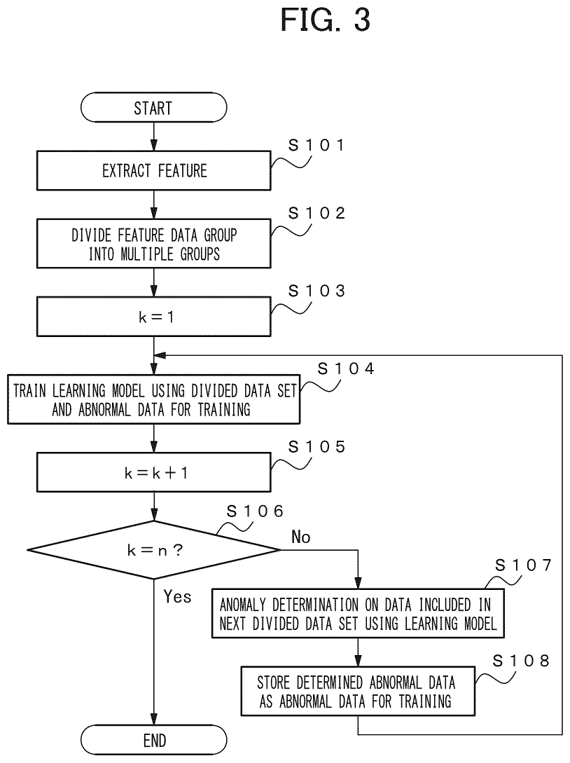

Next, the operation of the leaning model generator 100 is explained with reference to the flowchart in FIG. 3.

The feature detection unit 110 extracts a feature from the input data (step S101). The feature detection unit 110 stores the feature data indicating the extracted feature in the data storage 120.

The data division unit 130 divides a feature data group stored in the data storage 120 into multiple groups (divided data sets) (step S102). The data division unit 130 stores the divided data sets in the divided data set storage 140.

The learning model generation unit 150 sets the variable k to 1 (step S103).

As shown in FIG. 2, the learning model generation unit 150 provides the k-th (in this case, the first) divided data set and the abnormal data (abnormal data for training) stored in the abnormal data storage 170 to the learning model 200 to train the learning model 200 (step S104). When k=1, no abnormal data is stored in the abnormal data storage 170. Therefore, when k=1, the learning model 200 is trained using only the first divided data set (corresponding to x₁ in FIG. 2).

The learning performed when k≥2 can be said to be re-training.

The learning model generation unit 150 increases the value of variable k by 1 (step S105). When the value of variable k reaches n (division number), the process is terminated (step S106).

When the value of variable k is less than n, the anomaly determination unit 160 performs anomaly determination on the feature data included in the next divided data set (divided data set xₖ) using the learning model y₍ₖ₋₁₎ (step S107). The anomaly determination unit 160 stores the determined abnormal data group in the abnormal data storage 170 as abnormal data for training (step S108). Then, it returns to the process of step S104.

The process shown in FIG. 3 results in a trained learning model 200. Specifically, when the value of variable k is determined to have reached n (division number) in step S106, then the leaning model 200 becomes the trained leaning model.

In this example embodiment, the case of generating a learning model mainly used for detecting anomaly caused by radio interference, radio disturbance, etc. is used as an example. However, the learning model generator 100 of this example embodiment is not limited to anomaly caused by radio interference, radio disturbance, etc., but can also generate learning models used to detect anomaly based on other factors. Examples of detecting anomaly based on other factors include detecting outliers in IoT (Internet of Things), detecting malware, determining whether a product is good, etc.

In the estimation phase, anomaly detection is performed using the trained learning model 200. Therefore, the feature of input data, i.e., feature data, that is the target of anomaly detection is input to the learning model 200. The learning model 200 outputs an estimation result of whether the feature data is normal data or abnormal data.

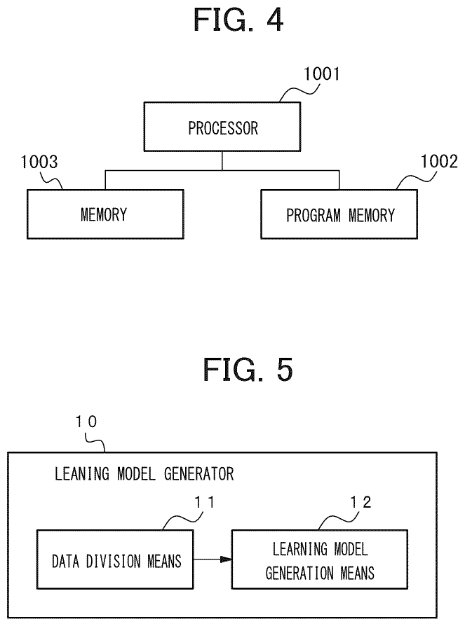

FIG. 4 is a block diagram showing an exemplary configuration of an information processing device (computer) that can realize the functions of the learning model generator 100 of the above example embodiment. The information processing device shown in FIG. 4 includes one or more processors such as one or more CPUs (Central Processing Unit), a program memory 1002 and a memory 1003. FIG. 4 illustrates an information processing device having one processor 1001.

The program memory 1002 is, for example, a non-transitory computer readable medium. The non-transitory computer readable medium is one of various types of tangible storage media. For example, as the program memory 1002, a semiconductor storage medium such as a flash ROM (Read Only Memory) or a magnetic storage medium such as a hard disk can be used. In the program memory 1002, a learning model generation program for realizing functions of blocks (the feature detection unit 110, the data division unit 130, the learning model generation unit 150, and the anomaly determination unit 160) in the learning model generator 100 of the above example embodiment is stored.

The processor 1001 realizes the function of the learning model generator 100 by executing processing according to the learning model generation program stored in the program memory 1002. When multiple processors are implemented, they can also work together to realize the function of the learning model generator 100.

For example, a RAM (Random Access Memory) can be used as the memory 1003. In the memory 1003, temporary data that is generated when the learning model generator 100 executes processing, etc. are stored. It can be assumed that the learning model generation program is transferred to the memory 1003 and the processor 1001 executes processing based on the learning model generation program in the memory 1003. The program memory 1002 and the memory 1003 may be integrated into a single unit.

The data storage 120, the divided data set storage 140, and the abnormal data storage 170 can be built in memory 1003. The learning model 200 is, for example, built in the memory 1003. The leaned learning model 200 can be ported to other information processors. That is, a learning model generated on one computer can be used on another computer.

FIG. 5 shows a block diagram of the main part of the learning model generator. The learning model generator 10 shown in FIG. 5 has data division means (data division unit) 11 (in the example embodiment, realized by the data division unit 130) for grouping multiple feature data, each of which indicates a feature, and learning model generation means (learning model generator) 12 (in the example embodiment, realized by the learning model generation unit 150) for generating a learning model using feature data belonging to a first group (for example, divided data set x₁) among multiple groups (for example, divided data sets x₁ to x₄) formed by the data division means 11, or the feature data belonging to the first group and a part of feature data belonging to other groups, as training data.

The learning model generator 10 may comprise feature extraction means (in the example embodiment, realized by the feature detection unit 110) for extracting features from each of the collected data, and the data division means 11 may be configured to group multiple feature data indicating the features extracted by the feature extraction means.

The learning model generator 10 may comprise anomaly determination means (in the example embodiment, realized by the anomaly determination unit 160) for determining whether the feature data belonging to the other groups is abnormal data or not, using the generated learning model, and the learning model generation means 12 may be configured to have the learning model re-train using feature data determined to be abnormal, regarding the feature data determined to be abnormal data as the part of feature data belonging to the other groups.

A part of or all of the above example embodiments may also be described as, but not limited to, the following supplementary notes.

(Supplementary note 1) A learning model generator comprising:
data division means for grouping multiple feature data, each of which indicates a feature, and
learning model generation means for generating a learning model using feature data belonging to a first group among multiple groups formed by the data division means, or the feature data belonging to the first group and a part of feature data belonging to other groups, as training data.
   (Supplementary note 2) The learning model generator according to Supplementary note 1, further comprising feature extraction means for extracting features from each of the collected data, wherein
the data division means groups the multiple feature data indicating the feature extracted by the feature extraction means.
   (Supplementary note 3) The learning model generator according to Supplementary note 2, further comprising anomaly determination means for determining whether the feature data belonging to the other groups is abnormal data or not, using the learning model generated by the learning model generating means, wherein
the learning model generation means has the learning model re-train using feature data determined to be abnormal by the anomaly determination means, regarding the feature data determined to be abnormal data as the part of feature data belonging to the other groups.
   (Supplementary note 4) The learning model generator according to Supplementary note 3, wherein
the anomaly determination means determines whether the feature data is abnormal data or not for all other groups, and
the learning model generation means has the learning model re-train for all other groups.
   (Supplementary note 5) The learning model generator according to any one of Supplementary notes 1 to 4, wherein
the anomaly determination means stores the feature data determined to be abnormal data in an abnormal data storage, and
the learning model generation means regards the abnormal data in the abnormal data storage as the part of feature data belonging to the other groups.
   (Supplementary note 6) A learning model generation method comprises:
grouping multiple feature data, each of which indicates a feature, and
generating a learning model using feature data belonging to a first group among multiple groups formed, or the feature data belonging to the first group and a part of feature data belonging to other groups, as training data.
   (Supplementary note 7) The learning model generation method according to Supplementary note 6, further comprising
extracting features from each of the collected data, and
grouping the multiple feature data indicating the extracted feature.
   (Supplementary note 8) The learning model generation method according to Supplementary note 7, further comprising
determining whether the feature data belonging to the other groups is abnormal data or not, using the generated learning model, and
having the learning model re-train using feature data determined to be abnormal, regarding the feature data determined to be abnormal data as the part of feature data belonging to the other groups.
   (Supplementary note 9) A learning model generation program causing a computer execute:
grouping multiple feature data, each of which indicates a feature, and
generating a learning model using feature data belonging to a first group among multiple groups formed, or the feature data belonging to the first group and a part of feature data belonging to other groups, as training data.
   (Supplementary note 10) The learning model generation program according to Supplementary note 9, causing a computer execute
extracting features from each of the collected data, and
grouping the multiple feature data indicating the extracted feature.
   (Supplementary note 11) The learning model generation program according to Supplementary note 10, causing a computer execute
determining whether the feature data belonging to the other groups is abnormal data or not, using the generated learning model, and
having the learning model re-train using feature data determined to be abnormal, regarding the feature data determined to be abnormal data as the part of feature data belonging to the other groups.

1. A learning model generator comprises:
a memory storing software instructions, and
one or more processors configured to execute the software instructions to
group multiple feature data, each of which indicates a feature, and
generate a learning model using feature data belonging to a first group among multiple groups formed, or the feature data belonging to the first group and a part of feature data belonging to other groups, as training data.

2. The learning model generator according to claim 1, wherein
the one or more processors are configured to execute the software instructions to
extract features from each of the collected data, and
group the multiple feature data indicating the extracted feature.

3. The learning model generator according to claim 2, wherein
the one or more processors are configured to execute the software instructions to
determine whether the feature data belonging to the other groups is abnormal data or not, using the generated learning model, and
have the learning model re-train using feature data determined to be abnormal, regarding the feature data determined to be abnormal data as the part of feature data belonging to the other groups.

4. The learning model generator according to claim 3, wherein
the one or more processors are configured to execute the software instructions to
determine whether the feature data is abnormal data or not for all other groups, and
have the learning model re-train for all other groups.

5. The learning model generator according to claim 1, wherein
the one or more processors configured are to execute the software instructions to
store the feature data determined to be abnormal data in an abnormal data storage, and
regard the abnormal data in the abnormal data storage as the part of feature data belonging to the other groups.

6. The learning model generator according to claim 2, wherein
the one or more processors are configured to execute the software instructions to
store the feature data determined to be abnormal data in an abnormal data storage, and
regard the abnormal data in the abnormal data storage as the part of feature data belonging to the other groups.

7. The learning model generator according to claim 3, wherein
the one or more processors are configured to execute the software instructions to
store the feature data determined to be abnormal data in an abnormal data storage, and
regard the abnormal data in the abnormal data storage as the part of feature data belonging to the other groups.

8. The learning model generator according to claim 4, wherein
the one or more processors are configured to execute the software instructions to
store the feature data determined to be abnormal data in an abnormal data storage, and
regard the abnormal data in the abnormal data storage as the part of feature data belonging to the other groups.

9. A learning model generation method comprises:
grouping multiple feature data, each of which indicates a feature, and
generating a learning model using feature data belonging to a first group among multiple groups formed, or the feature data belonging to the first group and a part of feature data belonging to other groups, as training data.

10. The learning model generation method according to claim 9, further comprising
extracting features from each of the collected data, and
grouping the multiple feature data indicating the extracted feature.

11. The learning model generation method according to claim 10, further comprising
determining whether the feature data belonging to the other groups is abnormal data or not, using the generated learning model, and
having the learning model re-train using feature data determined to be abnormal, regarding the feature data determined to be abnormal data as the part of feature data belonging to the other groups.

12. A non-transitory computer readable storage medium for storing a learning model generation program for causing a computer to execute:
grouping multiple feature data, each of which indicates a feature, and
generating a learning model using feature data belonging to a first group among multiple groups formed, or the feature data belonging to the first group and a part of feature data belonging to other groups, as training data.

13. The non-transitory computer readable storage medium according to claim 12, wherein
the learning model generation program causes the computer to execute
extracting features from each of the collected data, and
grouping the multiple feature data indicating the extracted feature.

14. The non-transitory computer readable storage medium according to claim 13, wherein
the learning model generation program causes the computer to execute
determining whether the feature data belonging to the other groups is abnormal data or not, using the generated learning model, and
having the learning model re-train using feature data determined to be abnormal, regarding the feature data determined to be abnormal data as the part of feature data belonging to the other groups.
